(19) United States
(12) Patent Application Publication
(10) Pub. No.: US 2013/0159060 A1
(43) Pub. Date: Jun. 20, 2013

(54) MONITORING AND CONTROL OF BUSINESS PROCESSES AND SCENARIOS

(71) Applicant: Jochen Steinbach, Bad Schoenborn (DE)

(72) Inventor: Jochen Steinbach, Bad Schoenborn (DE)

(21) Appl. No.: 13/325,546

(22) Filed: Dec. 14, 2011

(51) Int. Cl. G06Q 10/06

(52) U.S. Cl. 705/7.36

(57) ABSTRACT

A business process relating to a reference business object and a specific instance of the business process to which the specific instance of the business object belongs can be identified. Instances of other business objects related to the identified specific instance of the business process or business scenario can be retrieved, and a status of each business process feature in the specific instance of the business process or business scenario can be calculated. A navigation pane of the user interface can display a plurality of first user interface elements illustrating a sequence of the plurality of business process features required to complete the business process or business scenario instance. The plurality of user interface elements can indicate a status of process steps for the identified specific instance of the business process or business scenario.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

Modern integrated business software solutions, such as for example those with enterprise resource planning (ERP) feature sets, can assist users in performing a wide variety of business related tasks that can typically be grouped into business processes that include a number of process steps and that may require action (e.g. completion of one or more tasks) by a large number of employees or other members of an organization. One or more business processes can be further grouped into a business scenario, which can be considered as a higher-level classification of related business processes. Each process step that is part of a business process can be associated with one or more user interface elements, screens, and the like via which a user interacts with specific software components to perform tasks related to completion of the process step. A complicated business process can involve multiple process steps, which can optionally be grouped into one or more sub-processes, and each step can include one or more tasks that may require interaction with the functionality of one or more feature modules of an enterprise resource planning (ERP) software system.

### SUMMARY

In one aspect, a method includes identifying a business process or business scenario relating to a reference business object within a business software system used by an organization and a specific instance of the business process or business scenario to which a specific instance of the reference business object belongs. The identity of the specific instance of the reference business object includes a unique key value assigned to the specific instance of the business object and a business object type. The business process or business scenario includes a plurality of business process features required for completion of the business process or business scenario. Instances of other business objects that are related to the identified specific instance of the business process are retrieved, and a status of at least one business process feature in the specific instance of the business process or business scenario is calculated. A plurality of first user interface elements illustrating a sequence of the plurality of business process features required for completion of the business process or business scenario and a status of one or more of the plurality of business process features for the identified specific instance of the business process or business scenario are displayed in a navigation pane of a user interface.

In some variations one or more of the following features can optionally be included in any feasible combination. The identity of the reference business object can optionally be determined based on at least one of a user-entered identification of a document related to the reference business object and a workspace user interface element currently displayed to the user via the user interface. The identifying of the business process or business scenario can optionally include comparing the identity of the specific instance of the business object to a model of inter-object dependencies. The model of inter-object dependencies can optionally include relationships between at least one of a specific business process and a specific business scenario that are part of a business configuration of the business software system for an organization. The model can optionally include a decision table that cross-references an identity of each of a plurality of available business objects with at least one of a plurality of business processes and/or business scenarios to which each business object is relevant. At design time, a definition of the business process or business scenario, which can optionally include a designation of a plurality of business process features required for completion of the business process or business scenario, one or more feature modules of an business software system providing functionality relating to a specific process step of the plurality of process steps, and an order in which the plurality of process steps are to be executed, can optionally be created. At least two of the plurality of process steps can optionally require action by different feature modules of the enterprise resource planning software system. The calculating of the status of at least one process step in the specific instance of the business process or business scenario can optionally include at least one of applying a set of status determination rules to data in the retrieved other business objects, and aggregating data retrieved from a plurality of the retrieved other business objects to determine the status of a single one of the at least one business process feature.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, users can receive assistance in understanding dependencies between functionality of available ERP feature modules in each of numerous end-to-end business processes relevant to an organization. Rather than being constrained to isolated views of individual user interface screens related to individual task without access to information regarding how that task is contextually related to other tasks in a business process, an end-to-end overview is provided for all process steps and/or sub-processes related to a given document (e.g a sales order, purchase order, delivery, or invoice) or other task-related user interface with which a user is currently working. This end-to-end overview can also provide information regarding the status of the process steps or sub-processes involved in completion of a specific instance of the business process. A user can thereby easily and efficiently check on the progress of a specific instance of a business process, including viewing visual indications of which steps or sub-processes of the business process have already been completed, which are in progress, and which have yet to be started. Implementations of the current subject matter can also enable a user to directly carry out process steps or initiate actions from other people.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating two different access modes for user interface views in a multi-function software system;

FIG. 2 is a process flow diagram illustrating aspects of a method having one or more features consistent with implementations of the current subject matter;

FIG. 3 is a diagram illustrating relationships between a reference business object instance, a business process, the process steps of a business process, associated business object instances, and status determinations consistent with an implementation;

FIG. 4 is a first screenshot of a user interface showing features consistent with the current subject matter;

FIG. 5 is a second screenshot of a user interface showing features consistent with the current subject matter;

FIG. 6 is a diagram illustrating aspects of a system showing features consistent with implementations of the current subject matter;

FIG. 7 is a diagram illustrating aspects of a system showing features consistent with implementations of the current subject matter; and

FIG. 8 is a diagram illustrating a data repository showing features consistent with implementations of the current subject matter.

When practical, similar reference numbers denote similar structures, features, or elements.

### DETAILED DESCRIPTION

Integrated end-to-end business scenario (as an illustrative example, an order process that begins with generation of a sales quote and terminates with payment received) can be quite complex. A user can have difficulty understanding precisely where a specific instance of a business process or business scenario is along the sequence of business process features (e.g. process steps, sub-processes, tasks, etc.) that need to be performed to bring the business process or business scenario to completion. For example, a user may wish to know where a specific instance of a business process or a business scenario (e.g. the delivery of a sales order, etc.) is in the progression of a business process or a business scenario, if and why and at what point in the process a specific instance has become stuck (e.g. progress has temporarily halted because an approval is necessary, but has not been done), and what needs to happen next and who is the responsible user. If the user has the authority rights, he or she can advantageously be enabled to perform process steps directly from business process or business scenario monitor or navigation functionality that is integrated within a business software architecture.

Conventional ERP systems and their associated user interface features are often directed to support standalone transactions with specific key capabilities without necessarily providing a user with convenient access to information about how these capabilities fit into one or more specific instances of a business process or business scenario, which can include multiple business processes, process steps, transactions, tasks, or sub-processes composed of multiple tasks or transactions.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

Currently available approaches to guidance through the user interface features of a complicated, multi-featured ERP system generally rely upon a document flow approach, in which a user can access all instances of a first type of business object (for example sales orders, purchase orders, service orders, etc.). However, a document flow approach is typically only backward looking. While a user can view completed instances of various types of business objects, and can access related business object instances based on a common identifier (e.g. an order number or the like) provided that the related business object instances have already been created and populated with the common identifier, the document flow approach tends to omit important information relating to how the various business object instances relate to one or more of a plurality of tasks or sub-processes that make up a business process. Accordingly, a user may not be able to access a live map of where a current process step or business process feature whose user interface (UI) he or she is viewing or using fits into an overall business process or business scenario and can therefore lack important information regarding next or previous business process features within the business process or business scenario. Additionally, a document flow approach is generally based on business objects or documents and a sequence of how these entities relate to one another. A process or scenario monitor consistent with implementations of the current subject matter can be capable of showing a flow of business processes, process steps, or other business process features. While a document flow approach might be capable of giving a snapshot of a current status, such an approach is generally unable to show how that status was achieved (e.g. which business processes, process steps, or other business process features preceded the current status in a given instance of a business process or a business scenario.

On a daily basis, a user might process multiple instances of a specific type of business object belonging to multiple different instances of one or more business processes. In effect, such a user could be considered as operating in a “batch” mode—the one or more process steps related to each business object are performed largely independently of any knowledge of the business process context of the specific instance of the business process to which a given business object instance belongs. Implementations of the current subject matter allow a more process-centric view that groups instances of different types of business objects to enable navigation between all or at least some of the business object instances related to a given business process instance.

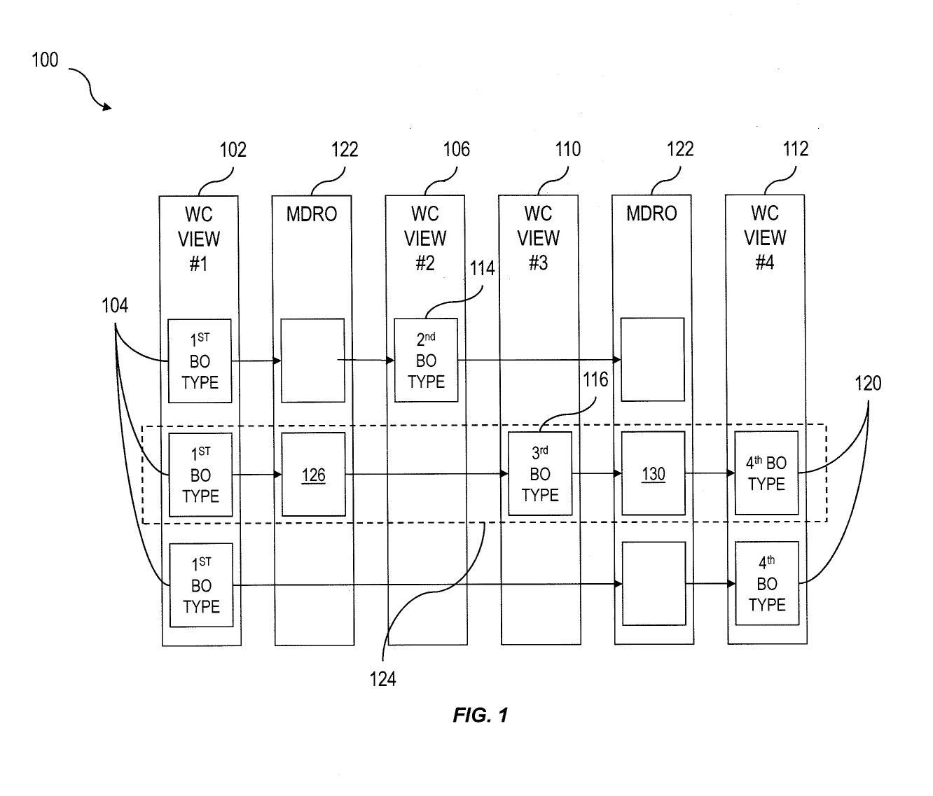

FIG. 1 shows a diagram 100 illustrating two different perspectives on user interface element views. A traditional approach to providing access to multiple instances of a business object or other type of ERP functionality involves one or more work center views or other user interface screens or groups of user interface elements via which a user can process multiple instances of similar business objects. For example, a first work center view 102 directed to handling instances of a first business object type 104 (e.g. purchase orders, sales orders, quotes, delivery schedules, production orders, etc.) may allow a clerk or other user to view a set of instances of the first business object type 104 regardless of the specific instance of a given process to which the particular instance of the first business object type 104 belongs. Similarly, a second work center view 106, a third work center view 110 and a fourth work center view 112 respectively directed to handling instances of a second business object type 114, a third business object type 116, and an Nth business object type 120 may allow a clerk or other user to view a set of business object instances of the particular type regardless of the specific instance of a given process to which the particular business object instance belongs. Depending on the particulars of a given business subject type, one or more mass data run objects (MDROs) 122 may be called as part of a business process. A MDRO is an object that controls a mass data run on a selected set of objects. A mass data run can include an automatic and parallel processing of a set of selected objects (e.g. data objects, metadata objects, business subjects, etc.) according to a set of business rules.

While a business object instance centric view of a work flow can be useful for certain tasks and user roles, other users may wish or need to have a more business process or business scenario centric view of the work flow that shows instances of other business object types related to a specific business process or business scenario instance to which a particular instance of the business object type is related or otherwise belongs. Accordingly, implementations of the current subject matter can provide a process or scenario instance centric view of work flow. As illustrated in FIG. 1, a business process or business scenario instance 124 can have related to it an instance of the first business object type 104, a first MDRO instance 126, an instance of the third business object type 116, a second MDRO instance, and an instance of the fourth business object type 120. A navigation view can be provided that allows a user to readily move between instances of different business object types that are related to a common business process or business scenario instance and that, in some implementations, also provides real-time (or at least semi-real time or periodically updated) information on a current status of business processes, process steps, or other business process features that are associated with the common business process instance.

Additionally, a conventional document flow approach may be incapable of providing a user view of linkages between business process features as they are related within a common business process. Likewise, navigation from a first task-specific UI screen relating to a first instance of a first type of business object to a second task-specific UI screen relating to a second instance of a second, different type of business object that is part of the same instance of a common business process may not be supported by a document flow approach. For example, if a user employing a document flow approach wishes to see details relating to a document, he or she may be able to conveniently launch only one user interface that is associated with a current business object underlying the documents that relate to it. A process or scenario-based perspective can instead allow the launch of one or more user interfaces that are related to a specific business process or business process feature within a business process or business scenario. Knowledge of the specific business process feature and the business object underlying that specific business process feature can be used to more precisely launch the appropriate user interface.

A document flow approach can also lack updated information relating to a current status of each of the various business processes, process steps, and/or other business process features, or in other example, such information may be available only at a header level of a given business object instance, thereby requiring navigation to a specific instance of one or more business objects related to an instance of the business process or business scenario to ascertain a current status of a given business process feature. For example, a user who is interested in examining a status of a business process feature (e.g. a business process or a process step within a business process) of a process or scenario that has multiple associated business object instances would, in a document flow approach, be presented with the multiple instances of the underlying business object, each having a separate status, and would be required to manually or otherwise perform a calculation or further analysis to determine an overall status of the business process feature. While this approach can be merely inconvenient in a relatively small organization or for relatively simple business processes, in a larger organization in which multiple entities (e.g. users, departments, divisions, outside vendors or suppliers, contractors, etc.) may be responsible for completion of various aspects of a given business process, which can also include a large number of business process that are not always linearly mapped in time, the potential for confusion, miscommunication, and resultant inefficiencies is quite substantial. Additionally, acquiring data necessary to perform process analytics can be quite difficult without a robust tool for identifying relevant data objects, accessing the data contained therein that is related to a particular business process instance, and processing the accessed data to calculate a state of each process step for that business process or business scenario instance. In some implementations of the current subject matter, aggregation rules can be applied to automatically provide status information for a given business process feature.

A work center or other user interface view based on a document flow approach may not provide a user having multiple roles with sufficient context to be able to efficiently determine how the provided capabilities are included within a business process or business scenario related workflow. Workflow items can include specific tasks that are delegated to a user to compose activities of a business process or business scenario. Features such as a business adaptation catalog or the like can provide a view based on a specific business scenario or process but are generally limited to a design time view on a business process or business scenario template that is not readily viewable by an end user and that cannot reflect run time modifications or progress toward completion of the overall process or scenario or of specific business process features within the process or scenario.

In an illustrative example, a business scenario called “to-stock procurement” can deal with an end-to-end business scenario that can include planning, purchasing, purchase orders, receipts, payments, etc. Such a business scenario can in this example include business processes such as plan supply, trigger purchasing, process purchase requests, process requests for quotes, process purchase orders, process expedited receipts, process advised receipts, create return-to-supplier requests, process delivery proposals, process supplier invoices, process payables, transfer bank files, and process bank statement.

At a higher level of granularity, the plan supply business process can include process steps of plan supply for product and optionally, resolve exceptions. The trigger purchasing business process can include a process step of release purchase requisition, while the process purchase requests business process can include a process step of purchase request sourcing. The business processes of process requests for quotes (RFQ) can be optional in this example, and can optionally include further process steps such as create RFQ, send RFQ, create quote, and award quote. The process purchase orders business process can likewise include the process steps of maintain purchase order, approve, send, and maintain acknowledgment, one or more of which can be optional depending on the details of the particular instance of the business scenario. The process expedited receipts business process can include a process step of post goods received (GR) or create inbound delivery notification (IDN). The process advised receipts business process can be an optional business process whose process steps can include post GR or write warehouse (WH) request, create tasks, confirm tasks, approve deviations, post corrections, and release inbound delivery. The create return-to-supplier requests business process can include a process step of create return requests, and the process delivery proposals business process can include post GR or write WH request process steps, and optionally the process steps of create tasks, confirm tasks, approve deviations, post corrections, and release inbound delivery. The process supplier invoices business process can include the process steps of create supplier invoice and optionally resolve exceptions and post, and approve (e.g. if there are exceptions). The process payables business process can include the process steps of create payment and optionally, approve and create file/print check. The transfer bank files business process can be an optional one, which can also include the process steps of the release, transfer, and confirm. The process bank statement business process can include the process step of maintain bank statement.

In another example, a business scenario call “sell project based services” can deal with an end-to-end business scenario that can include business processes such as project management, non-stock procurement, time recording, expense management, ad hoc goods movements, and customer project invoice processing. The manage project business process can include process steps such as create project, plan and release project, approve baseline, trigger purchase request, and document task progress. The time recording business process business process can include the process steps of edit time sheet and approve time sheet. An expense management business process can include process steps such as create expense report, review expense report, and approve expense report. An ad hoc good movements business process can include process steps such as confirm good movement, and a customer project invoice processing business process can include process steps such as create invoice request and release invoice request.

Implementations of the current subject matter can provide advantages in improving clarity and ease of navigation through a rich feature set provided by an ERP software architecture or other software system with significant complexity. A currently in-progress instance of a business process or business scenario can be monitored to provide one or more of live navigation through the instance (e.g. by providing a graphical, interactive map display for moving between task-related user interface screens relating to completion of process steps or sub-processes), current status information relating to progress toward completion of each business process feature of the business scenario, business analytics, and the like. Business objects and modeling of business processes or business scenarios that rely on interaction of the business objects can be leveraged to present an overview of a specific instance of the business process or business scenario as well as how that business process or business scenario has been customized relative to a “stock” or default business process or business scenario template for use by users at a given organization (e.g. company, department, etc. that uses an ERP system).

Implementations of the current subject matter can also provide dynamic determination of a current status for each business process feature within a specific instance of a business process or business scenario. For example, instances of business objects that are determined to be relevant or otherwise related to a current business process or business scenario instance can be retrieved, for example from a metadata repository or other data repository. One or more status determination rules can be applied to the retrieved business objects to calculate a current status of the current business process or business scenario instance. Underlying computations and data analysis infrastructures can be provided to enable live calculations of the status of each business process feature of a business process or business scenario. In this manner, dynamic determination of which specific business scenario or subset of business scenarios are linked to a given work center or other current user context can be enabled.

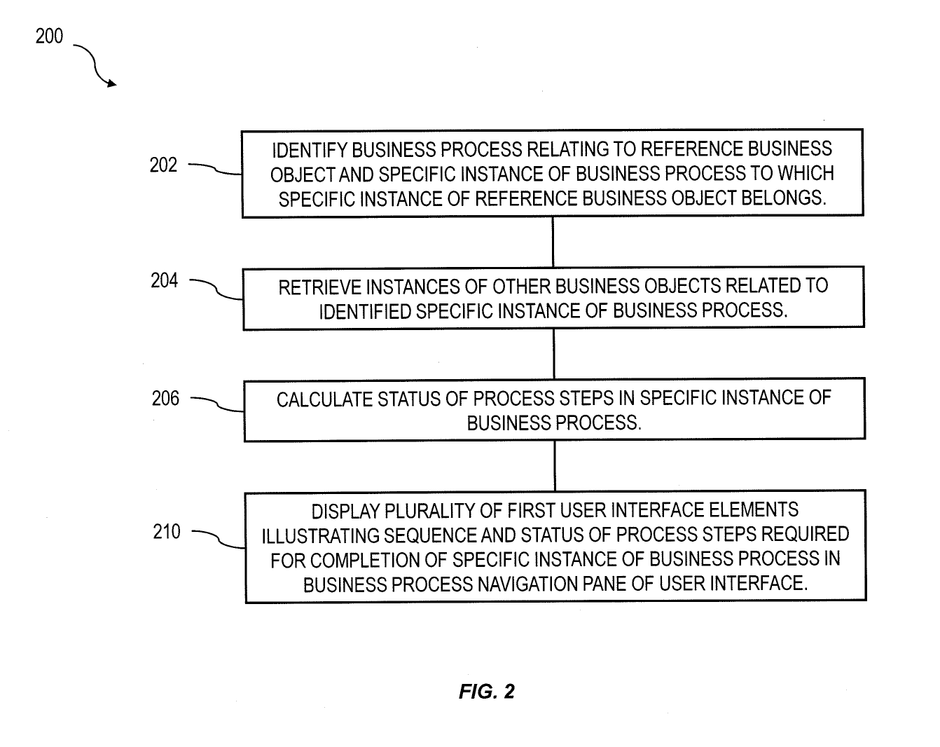

In one implementation, a method can include features such as those illustrated in FIG. 2, which depicts a process flow chart 200. At 202, a business process or business scenario relating to a reference business object and a specific instance of the business process or business scenario to which a specific instance of the business object belongs can be identified based on an identity of the specific instance of the reference business object underlying a workspace user interface element currently displayed to a user via a user interface. The identity of the specific instance of the reference business object can include a unique key value assigned to the specific instance of the business object and a business object type. The business process or business scenario can include a plurality of business process features required for completion of the business process or business scenario. Instances of other business objects that are related to the identified specific instance of the business process or business scenario can be retrieved at 204, and a status of one or more of the business process features in the specific instance of the business process or business scenario can be calculated at 206, for example by applying a set of status determination rules to data in the retrieved other business object instances. At 210, a navigation pane of the user interface can display a plurality of first user interface elements illustrating a sequence of the plurality of business process features required for completion of the business process or business scenario and a status of one or more of the plurality of business process features for the identified specific instance of the business process or business scenario.

A further feature of certain implementations of the current subject matter can include creating a definition of the business process or business scenario. Such a definition can include a designation of one or more business process features that make up an end-to-end business process or business scenario. A specific instance of the business process or business scenario can proceed according to the definition as modified by real world conditions. The defining of business process features of a business process or business scenario can typically be performed at design time, although in some implementations the defining can occur at run time, for example if one or more user interface screens or elements are provided to facilitate customization of a process or scenario by a user.

The identifying of the business process or business scenario relating to the reference business object can be accomplished in some implementations via a lookup table or other data structure or model that correlates business object types with business processes or business scenarios that incorporate those types. In one example, a where-used list, table or other database can be prepared or otherwise generated. The where-used list (or other functional equivalent) can provide a convenient lookup mechanism or otherwise act as an index via which a business object type of a reference business object instance can point to one or more business processes or business scenarios that incorporate functionality of that business object type. In an example where functionality of a reference business object type is incorporated into more than one business process or business scenario, implementations of the current subject matter can include presenting a user with a list, menu, etc. of the more than one business process or business scenario relating to the reference business object. In another implementation, a “best” choice among the more than one business process or business scenario options can be selected, for example based on an algorithm or priority listing using as inputs a user role (e.g. via a defined set of business processes or business scenarios to which the user role is linked), a recent user context (e.g. other business objects the user has recently interacted with), a user permission level, or the like.

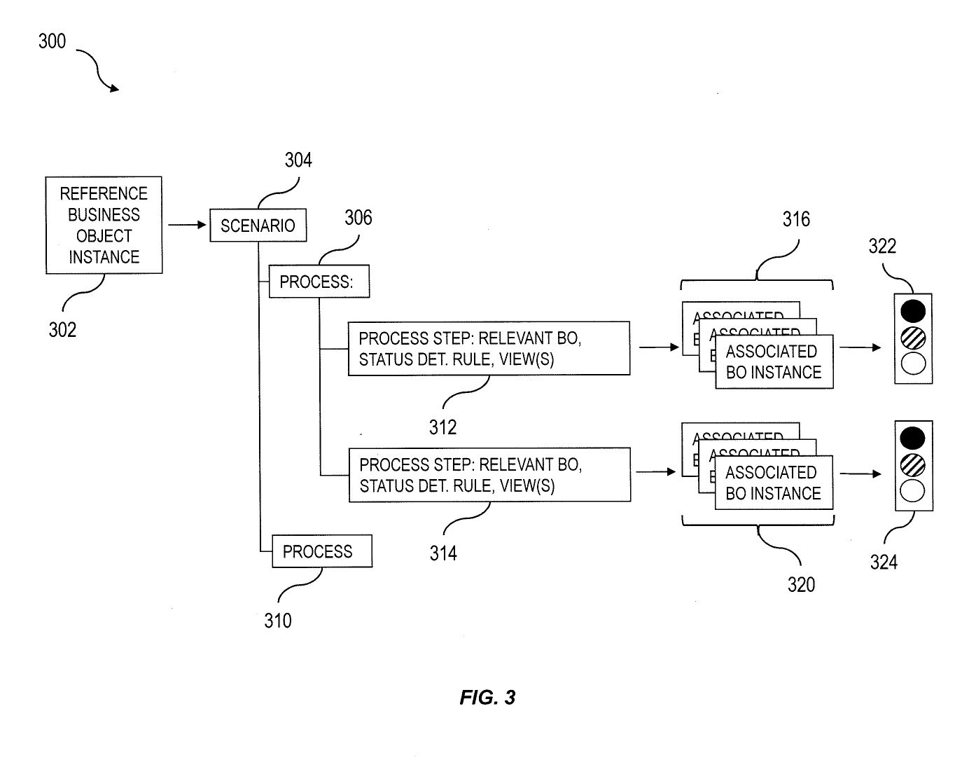

FIG. 3 shows a diagram illustrating an exemplary modeling framework 300 showing relationships between instances of other business objects related to the identified specific instance of a business process or business scenario. The type of the reference business object 302 type can be linked to a business scenario 304, which can be a set of business processes including a first business process 306 and optionally a second business process 310 and/or additional business processes. Once it is determined, for example using an approach as discussed above or by some other means, that the first business process 306 is related to the reference business object, the business process features (e.g. process steps) 312, 314 of that business process 306 are identified, for example based on a definition of the business process 306. Each process step can include one or more corresponding (e.g. relevant) business objects; status determining rules; user interface screens; elements, views, etc.; and the like. Each such corresponding element can in turn have associated with it or otherwise point to one or more business object instances that are associated with a specific instance of the business process 306 to which the reference business object instance 302 has been determined to correspond. Based on a set of rules or some other algorithmic determination, a current status 322,324 of one or more of the business process features 312, 314 can be determined for the specific instance of the business process 306. In one example, the determined status for the one or more business process features 312, 314 can be one of not yet started, in progress, and completed. As discussed further below a navigation user interface feature or features can be provided that shows a user where in the specific process or scenario instance he or she is currently working and that optionally also further shows the determined status for at least one of the business process features 312, 314 for that instance of the business process or business scenario. In one example, the showing of the business process feature status can be via one or more icons. For example, a traffic signal icon could indicate a different pattern or color (e.g. red, yellow, green, etc.) corresponding to each status for the one or more business process features.

In making the calculation of status for a given business process feature 312, 314, data extracted from more than one associated business object instance can be aggregated. For example, the designation of business process features in the business process or business scenario definition can include business process features that require more than one task or sub-step to complete and that can therefore rely on data from multiple business object instances. Data relating to stepwise linkages of the associated business object instances as they relate to a given business process feature or sequence of business process features can be queried and used to determine status information. Alternatively, a more efficient calculation of status information can be obtained in some examples by directly querying business subject via their header information, which can in some cases include sufficient information about related business object types to obviate the need to retrieve and read the entirety of each business object instance.

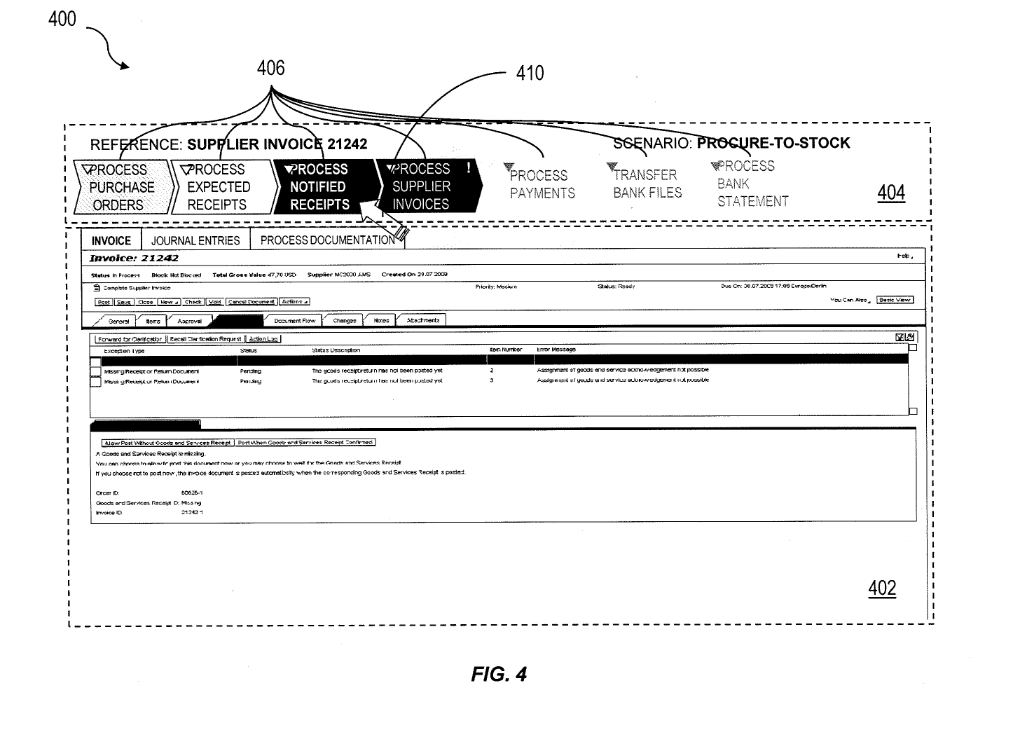

FIG. 4 shows a first screen shot 400 of an example of a user interface into which features of the current subject matter can be incorporated. A work pane 402 can display user interface elements via which a user can interact with one or more features of the system. These features can be based on one or more business objects, one of which can be determined to be the reference business object as discussed above. Based on the reference business object, a business process that the user is working with can be identified. A navigation pane 404 can be displayed, for example concurrently with the work pane 402, and can include navigation user interface elements 406 relating to discrete process steps in the identified business process or business scenario. The navigation user interface elements 406 can further include one or more of visual (e.g. shape, color, pattern, font, etc.) and textual (e.g. labels, windows that are displayed when a user “mouses over,” etc.) cues indicating a current status or other information of the particular business process feature in the specific instance of the business process or business scenario to which the currently active instance of the reference business object corresponds. In the example of FIG. 4, the hashed navigation user interface element 406 can indicate completed business process features, the white navigation user interface element 406 can indicate in-progress business process features, the black navigation user interface element 406 can indicate business process features that are in-progress and waiting on action by the current user, and the grayed out navigation user interface elements 406 can indicate business process features that have not yet commenced.

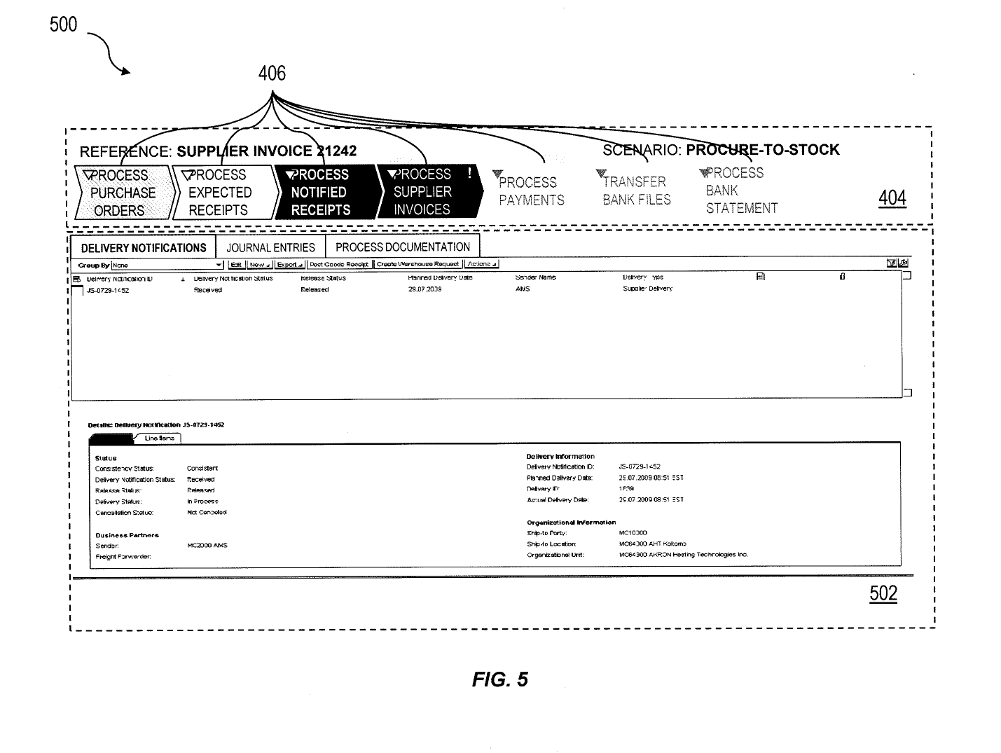

Selection of one of the navigation user interface elements 406, for example one corresponding to a business process feature that is in-progress and waiting on action by the current user as indicated by the arrow 410 in FIG. 4, can cause the work pane 402 to display a different work pane 502 with a different set of user interface elements relating to the business process feature corresponding to the selected navigation user interface element 406, for example as shown in the screenshot 500 of FIG. 5.

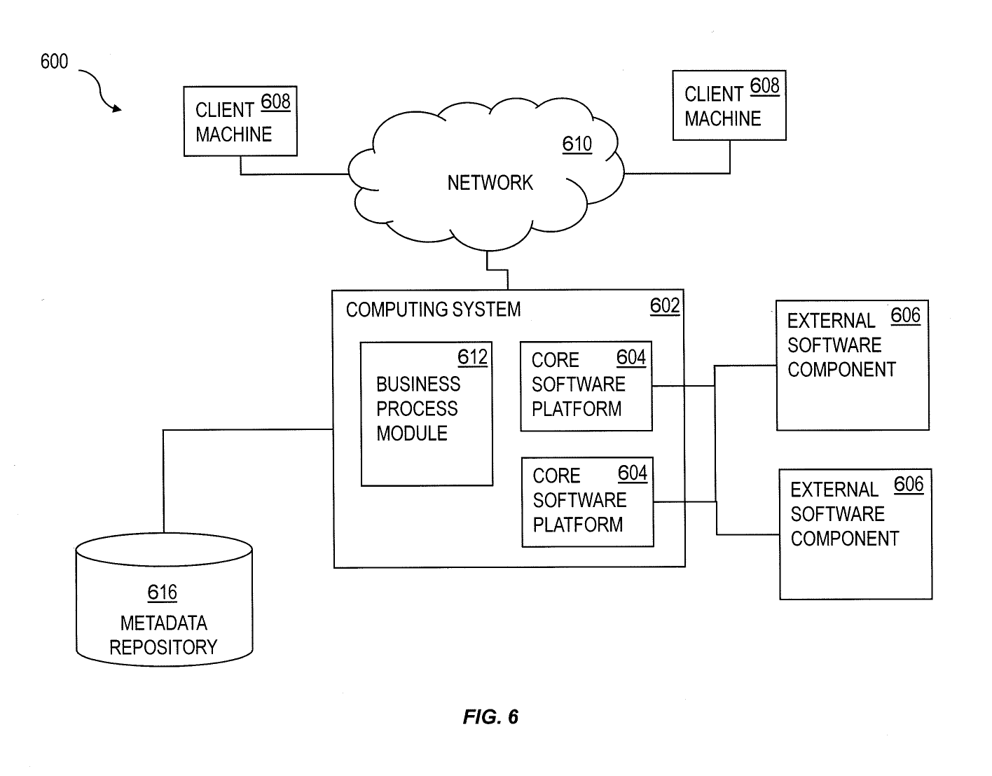

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 6 shows a diagram of a system consistent with such an implementation. A computing system 602 can include one or more core software platform modules 604 providing one or more features of the ERP system. The computing system can also aggregate or otherwise provide a gateway via which users can access functionality provided by one or more external software components 606, which can optionally be provided by one or more service providers external to the one or more core software platform modules 604. Client machines 608 can access the computing system, either via a direct connection, a local terminal, or over a network 610 (e.g. a local area network, a wide area network, a wireless network, the Internet, or the like). A business scenario guidance and recording module 612 can be hosted on the computing system 602 or alternatively, on an external system accessible over a network connection. The business scenario guidance and recording module 612 can optionally include one or more discrete software and/or hardware modules that perform operations such as those described herein.

The business scenario guidance and recording module 612 can access one or more metadata repositories 616 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 616.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

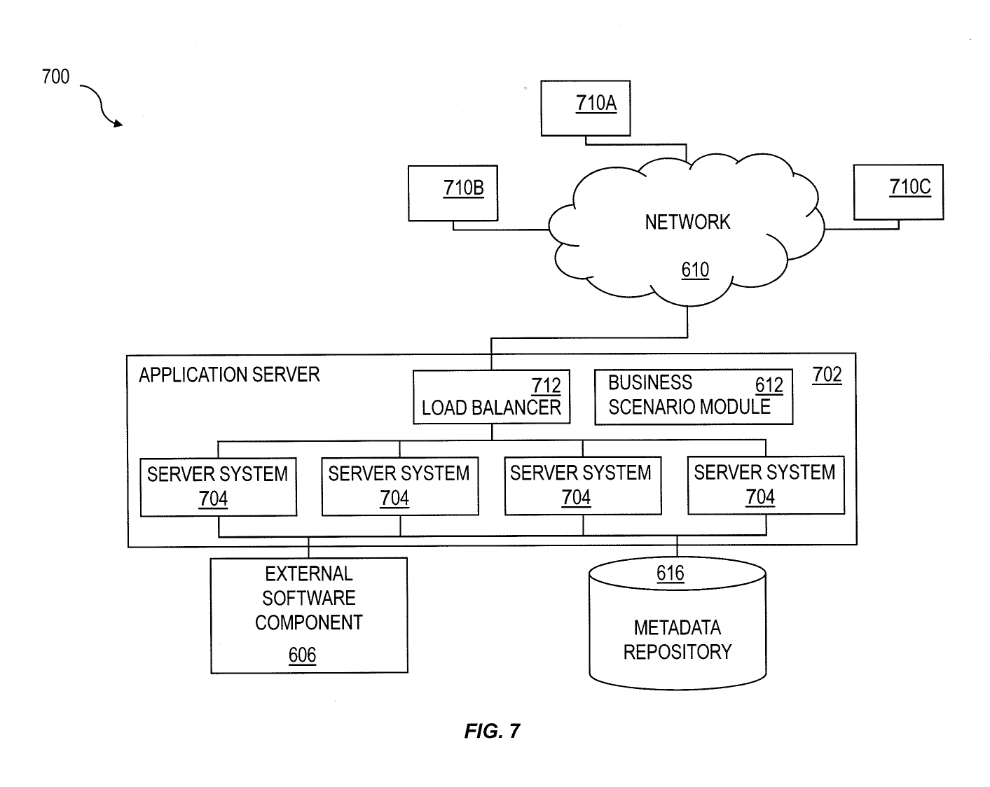

FIG. 7 shows a block diagram of a multi-tenant implementation of a software delivery architecture 700 that includes an application server 702, which can in some implementations include multiple server systems 704 that are accessible over a network 706 from client machines operated by users at each of multiple organizations 710A-710C (referred to herein as “tenants” of a multi-tenant system) supported by a single software delivery architecture 700. For a system in which the application server 702 includes multiple server systems 704, the application server can include a load balancer 712 to distribute requests and actions from users at the one or more organizations 710A-710C to the one or more server systems 704. Instances of the core software platform 604 (not shown in FIG. 7) can be executed in a distributed manner across the server systems 704. A user can access the software delivery architecture across the network using a thin client, such as for example a web browser or the like, or other portal software running on a client machine. The application server 702 can access data and data objects stored in one or more data repositories 616. The application server 702 can also serve as a middleware component via which access is provided to one or more external software components 606 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 702 that includes multiple server systems 704 that handle processing loads distributed by a load balancer 712. Potential benefits from such an arrangement can include, but are not limited to, high and reliably continuous application server availability and minimization of unplanned downtime, phased updating of the multiple server systems 704 to permit continuous availability (one server system 704 can be taken offline while the other systems continue to provide services via the load balancer 712), scalability via addition or removal of a server system 704 that is accessed via the load balancer 712, and de-coupled lifecycle processes (such as for example system maintenance, software upgrades, etc.) that enable updating of the core software independently of tenant-specific customizations implemented by individual tenants.

As in the example illustrated in FIG. 6, the metadata repository 616 can store a business object that represents a template definition of a standard business process. Each individual tenant 710A-710C can customize that standard template according to the individual business process features specific to business of the organization to which that tenant is assigned. Customizations can be stored as extensions in the metadata repository.

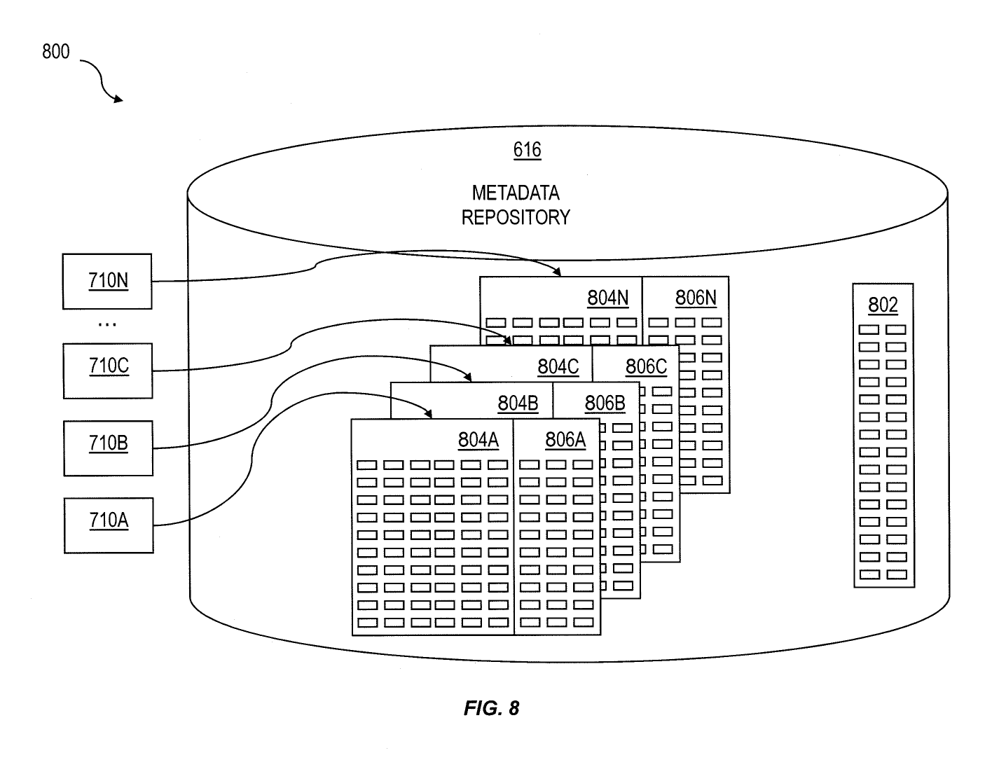

To provide for customization of the business scenarios and/or business processes for each of multiple organizations supported by a single software delivery architecture 700, the data and data objects stored in the metadata repository 616 and/or other data repositories that are accessed by the application server 702 can include three types of content as shown in FIG. 8: core software platform content 802 (e.g. a standard definition of a business process), system content 804, and tenant content 806. Core software platform content 802 includes content that represents core functionality and is not modifiable by a tenant. System content 804 can in some examples be created by the runtime of the core software platform and can include core data objects that store concrete data associated with specific instances of a given business process and that are modifiable with data provided by each tenant. The data retained in these data objects are tenant-specific: for example, each tenant 710A-710N can store information about its own inventory, sales order, etc. Tenant content 806A-806N includes data objects or extensions to other data objects that are customized for one specific tenant 710A-710N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 806 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 802 and system content 804 and tenant content 806 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer program product comprising a machine-readable medium non-transitorily storing instructions that, when executed by at least one programmable processor, cause the at least one programmable processor to perform operations comprising:
identifying a business process or business scenario relating to a reference business object within a business software system used by an organization and a specific instance of the business process or business scenario to which a specific instance of the reference business object belongs, the specific instance of the reference business object underlying a workspace user interface element currently displayed to a user via a user interface, the identity of the specific instance of the reference business object comprising a unique key value assigned to the specific instance of the business object and a business object type, the business process or business scenario comprising a plurality of business process features required for completion of the business process or business scenario, each of the business process features having one or more business objects associated with that business process feature;
retrieving instances of other business objects that are related to the identified specific instance of the business process, the retrieving comprising determining the business process or scenario to which the business object type is linked by a modeling framework, identifying the plurality of business process features of the business process or scenario to which the business object type is linked based on a definition of the business process or scenario, identifying one or more business object instances associated with each of the plurality of business process features for a specific instance of the business process or scenario to which the specific instance of the reference business object belongs;
calculating a status of the business process features in the specific instance of the business process or business scenario, the calculating comprising applying a set of rules to at least one of a) data extracted from the identified one or more business object instances associated with each business process feature for the specific instance of the business process or business scenario and b) header information directly queried via header information of the identified one or more business object instances associated with each business process feature for the specific instance of the business process or business scenario; and
displaying, in a navigation pane of a user interface, a plurality of first user interface elements illustrating a sequence of the plurality of business process features required for completion of the specific instance of business process or business scenario and the calculated status of one or more of the plurality of business process features for the specific instance of the business process or business scenario.

2. A computer program product as in claim 1, wherein the operations further comprise determining the identity of the reference business object based on at least one of a user-entered identification of a document related to the reference business object and a workspace user interface element currently displayed to the user via the user interface.

3. A computer program product as in claim 1, wherein the identifying of the business process or business scenario comprises comparing the identity of the specific instance of the business object to a model of inter-object dependencies, the model of inter-object dependencies comprising relationships between at least one of a specific business process and a specific business scenario that are part of a business configuration of the business software system for an organization.

4. A computer program product as in claim 3, wherein the model comprises a decision table that cross-references an identity of each of a plurality of available business objects with at least one of a plurality of business processes and/or business scenarios to which each business object is relevant.

5. A computer program product as in claim 1, wherein the operations further comprise creating, at design time, a definition of the business process or business scenario, the definition comprising a designation of a plurality of business process features required for completion of the business process or business scenario, one or more feature modules of an business software system providing functionality relating to a specific process step of the plurality of process steps, and an order in which the plurality of process steps are to be executed, at least two of the plurality of process steps requiring action by different feature modules of the enterprise resource planning software system.

6. A computer program product as in claim 1, wherein the calculating of the status of at least one process step in the specific instance of the business process or business scenario comprises at least one of applying a set of status determination rules to data in the retrieved other business objects, and aggregating data retrieved from a plurality of the retrieved other business objects to determine the status of a single one of the at least one business process feature.

7. A system comprising:
at least one programmable processor; and
a machine-readable medium storing instructions that, when executed by the at least one processor, cause the at least one programmable processor to perform operations comprising:
identifying a business process or business scenario relating to a reference business object within a business software system used by an organization and a specific instance of the business process or business scenario to which a specific instance of the reference business object belongs, the specific instance of the reference business object underlying a workspace user interface element currently displayed to a user via a user interface, the identity of the specific instance of the reference business object comprising a unique key value assigned to the specific instance of the business object and a business object type, the business process or business scenario comprising a plurality of business process features required for completion of the business process or business scenario, each of the business process features having one or more business objects associated with that business process feature;
retrieving instances of other business objects that are related to the identified specific instance of the business process, the retrieving comprising determining the business process or scenario to which the business object type is linked by a modeling framework, identifying the plurality of business process features of the business process or scenario to which the business object type is linked based on a definition of the business process or scenario, identifying one or more business object instances associated with each of the plurality of business process features for a specific instance of the business process or scenario to which the specific instance of the reference business object belongs;
calculating a status of the business process features in the specific instance of the business process or business scenario, the calculating comprising applying a set of rules to at least one of a) data extracted from the identified one or more business object instances associated with each business process feature for the specific instance of the business process or business scenario and b) header information directly queried via header information of the identified one or more business object instances associated with each business process feature for the specific instance of the business process or business scenario; and
displaying, in a navigation pane of a user interface, a plurality of first user interface elements illustrating a sequence of the plurality of business process features required for completion of the specific instance of business process or business scenario and the calculated status of one or more of the plurality of business process features for the specific instance of the business process or business scenario.

8. A system as in claim 7, wherein the operations further comprise determining the identity of the reference business object based on at least one of a user-entered identification of a document related to the reference business object and a workspace user interface element currently displayed to the user via the user interface.

9. A system as in claim 7, wherein the identifying of the business process or business scenario comprises comparing the identity of the specific instance of the business object to a model of inter-object dependencies, the model of inter-object dependencies comprising relationships between at least one of a specific business process and a specific business scenario that are part of a business configuration of the business software system for an organization.

10. A system as in claim 9, wherein the model comprises a decision table that cross-references an identity of each of a plurality of available business objects with at least one of a plurality of business processes and/or business scenarios to which each business object is relevant.

11. A system as in claim 7, wherein the operations further comprise creating, at design time, a definition of the business process or business scenario, the definition comprising a designation of a plurality of business process features required for completion of the business process or business scenario, one or more feature modules of an business software system providing functionality relating to a specific process step of the plurality of process steps, and an order in which the plurality of process steps are to be executed, at least two of the plurality of process steps requiring action by different feature modules of the enterprise resource planning software system.

12. A system as in claim 7, wherein the calculating of the status of at least one process step in the specific instance of the business process or business scenario comprises at least one of applying a set of status determination rules to data in the retrieved other business objects, and aggregating data retrieved from a plurality of the retrieved other business objects to determine the status of a single one of the at least one business process feature.

13. A computer-implemented method comprising:
identifying a business process or business scenario relating to a reference business object within a business software system used by an organization and a specific instance of the business process or business scenario to which a specific instance of the reference business object belongs, the specific instance of the reference business object underlying a workspace user interface element currently displayed to a user via a user interface, the identity of the specific instance of the reference business object comprising a unique key value assigned to the specific instance of the business object and a business object type, the business process or business scenario comprising a plurality of business process features required for completion of the business process or business scenario, each of the business process features having one or more business objects associated with that business process feature;
retrieving instances of other business objects that are related to the identified specific instance of the business process, the retrieving comprising determining the business process or scenario to which the business object type is linked by a modeling framework, identifying the plurality of business process features of the business process or scenario to which the business object type is linked based on a definition of the business process or scenario, identifying one or more business object instances associated with each of the plurality of business process features for a specific instance of the business process or scenario to which the specific instance of the reference business object belongs;
calculating a status of the business process features in the specific instance of the business process or business scenario, the calculating comprising applying a set of rules to at least one of a) data extracted from the identified one or more business object instances associated with each business process feature for the specific instance of the business process or business scenario and b) header information directly queried via header information of the identified one or more business object instances associated with each business process feature for the specific instance of the business process or business scenario; and
displaying, in a navigation pane of a user interface, a plurality of first user interface elements illustrating a sequence of the plurality of business process features required for completion of the specific instance of business process or business scenario and the calculated status of one or more of the plurality of business process features for the specific instance of the business process or business scenario;
wherein the identifying, the retrieving, the calculating, and the displaying are performed by at least one programmable processor.

14. A computer-implemented method as in claim 13, further comprising determining the identity of the reference business object based on at least one of a user-entered identification of a document related to the reference business object and a workspace user interface element currently displayed to the user via the user interface.

15. A computer-implemented method as in claim 13, wherein the identifying of the business process or business scenario comprises comparing the identity of the specific instance of the business object to a model of inter-object dependencies, the model of inter-object dependencies comprising relationships between at least one of a specific business process and a specific business scenario that are part of a business configuration of the business software system for an organization.

16. A computer-implemented method as in claim 15, wherein the model comprises a decision table that cross-references an identity of each of a plurality of available business objects with at least one of a plurality of business processes and/or business scenarios to which each business object is relevant.

17. A computer-implemented method as in claim 13, further comprising creating, at design time, a definition of the business process or business scenario, the definition comprising a designation of a plurality of business process features required for completion of the business process or business scenario, one or more feature modules of an business software system providing functionality relating to a specific process step of the plurality of process steps, and an order in which the plurality of process steps are to be executed, at least two of the plurality of process steps requiring action by different feature modules of the enterprise resource planning software system.

18. A computer-implemented method as in claim 13, wherein the calculating of the status of at least one process step in the specific instance of the business process or business scenario comprises at least one of applying a set of status determination rules to data in the retrieved other business objects, and aggregating data retrieved from a plurality of the retrieved other business objects to determine the status of a single one of the at least one business process feature.

19. (canceled)

20. A computer program product as in claim 1, wherein the calculating comprises applying a set of rules to data extracted from the identified one or more business object instances associated with each business process feature for the specific instance of the business process or business scenario, and further comprises aggregating data extracted from more than one business object associated with at least one of the business process features.
